(19) United States
(12) Patent Application Publication
(10) Pub. No.: US 2026/0009770 A1
(43) Pub. Date: Jan. 8, 2026

(54) HARD SHELL LENS WITH DOUBLE WALL STRUCTURE

(71) Applicant: GE Precision Healthcare LLC, Waukesha, WI (US)

(72) Inventor: Satoru Katsumata, Hino (JP)

(21) Appl. No.: 19/258,237

(22) Filed: Jul. 2, 2025

(30) Foreign Application Priority Data
Jul. 3, 2024 (JP) 2024-107653

(51) Int. Cl. G01N 29/24; G01N 29/06; G01N 29/22

(52) U.S. Cl. CPC G01N 29/2456; G01N 29/0609; G01N 29/0654; G01N 29/221

(57) ABSTRACT

An acoustic window including a convex surface that extends in an azimuth direction and contacts an examination target, and a first wall portion and a second wall portion that extend divergently from each other. At least a portion of the first wall portion is provided along an inner surface of the probe case, and the second wall portion has an outer surface that is contiguous with the convex surface.

### CROSS-REFERENCE TO RELATED APPLICATION

This application claims priority to Japanese Patent Application No. 2024-107653,which was file on Jul. 3, 2024 at the Japanese Patent Office. The entire contents of the above-listed application are incorporated by reference herein in their entirety.

### TECHNICAL FIELD

The present invention relates to an ultrasonic probe, and more particularly to an acoustic window component positioned relative to a probe case at an end part of the ultrasonic probe.

### BACKGROUND

When performing an ultrasonic examination, an operator can dispose an ultrasonic probe at any position on a scan target, orient the probe in any direction, perform imaging, and obtain a non-destructive/non-invasive ultrasonic image.

When performing this ultrasonic examination, the ultrasonic probe transmits an ultrasonic signal through a component called an acoustic window. Ultrasonic echo signals returning from the internal structure of a scanned object pass through the acoustic window, are received by a transducer positioned inside the acoustic window, and are converted into an electrical signal.

Acoustic windows that fulfill this role are required to resolve a variety of technical issues. For example, the energy of the received ultrasonic echo signal must be sufficiently high relative to the energy of the transmitted ultrasonic signal. If the material of the acoustic window has poor acoustic compatibility with living tissue (water) and the acoustic window has the property of reflecting a large amount of ultrasonic waves from the surface, or if the energy of the ultrasonic waves is significantly attenuated while passing through the acoustic window, the requirement for receiving ultrasonic echo signals with sufficiently high energy cannot be satisfied. Furthermore, ultrasonic waves have a property that the propagation speed changes depending on the medium through which the waves pass. The velocity of propagation through the acoustic window must be uniform and within a prescribed range.

On the other hand, when performing an abdominal ultrasonic echo examination, for example, the acoustic window may be pressed firmly against the abdomen that is the examination target, and a prescribed strength is required. The deformation of the acoustic window changes the distance between the transducer and the target organ, and also generates refraction in an undesired direction at the deformed portion. In this case, the accuracy of the ultrasonic image is reduced. If the thickness of the acoustic window is increased to increase the robustness, the signal strength problem described above will increase, and the requirement for robustness of the acoustic window and the requirement to prevent a reduction in signal strength due to the acoustic window are contradictory requirements. Even if a strong material is selected for the acoustic window in order to increase the robustness, this is often not desirable from the viewpoint of preventing a decrease in signal strength due to the acoustic window.

Furthermore, for example, when an ultrasonic probe is placed between the ribs of a target in order to perform an ultrasonic echo examination, the shape of the acoustic window may be designed to be thin in the elevation direction and have a smoothly curved surface to reduce pain to the target.

Furthermore, when ultrasonic testing is performed, various types of dirt and contaminants may adhere to the portion of the ultrasonic probe including the acoustic window, and bacteria may grow thereon. To prevent these problems from occurring and to prolong the lifespan of the ultrasonic probe, ultrasonic probe manufacturers provide users with guides for cleaning, disinfecting, and sterilizing the ultrasonic probe (e.g., “GE Healthcare Japan, Disinfection Guidelines by Modality”). According to the cleaning, disinfecting, and sterilizing guidelines, the surface of the ultrasonic probe is scrubbed with a sponge, washed with cleaning water, or immersed in a disinfectant solution for several minutes to several hours. Additionally, in certain ultrasonic probe applications, steam may be applied to disinfect and clean the ultrasonic probe. Therefore, the acoustic window is required to be made of a material that has excellent chemical resistance, heat resistance, and required rigidity.

### SUMMARY

A first aspect of the present disclosure provides an acoustic window. The acoustic window is positioned at the end part of the ultrasonic probe relative to the probe case. The acoustic window component includes a convex surface that extends in the azimuth direction and contacts the examination target, and a first wall portion and a second wall portion that extend divergently from each other. At least a portion of the first wall portion is provided along an inner surface of the probe case, and the second wall portion has an outer surface that is contiguous with the convex surface.

The second aspect of the present disclosure provides an ultrasonic probe including an acoustic window. The ultrasonic probe includes an acoustic window having the features of the first aspect of the present disclosure, a module including an ultrasonic transducer and an acoustic lens that focuses ultrasonic waves generated from the ultrasonic transducer, and a probe case that internally stores a main body of the ultrasonic probe.

The acoustic lens has a convex outer surface that corresponds to the concave shape of the rear surface of the acoustic window component, and the convex outer surface of the acoustic lens is acoustically bonded to the rear surface of the acoustic window component.

The third aspect of the present disclosure provides an ultrasonic probe. The ultrasonic diagnostic device includes an ultrasonic probe having the features of the second aspect of the present disclosure, an image processing unit that generates an ultrasonic image based on ultrasonic signals collected by the ultrasonic probe, and a display device that displays the ultrasonic image.

The fourth aspect of the present disclosure provides a method for manufacturing an acoustic window component. A method for manufacturing an acoustic window component includes a step of preparing a mold having an inner surface corresponding to an acoustic window having features of the first aspect of the present disclosure, and a step of injection molding the acoustic window component by injecting molten thermoplastic polymer into the mold.

The fifth aspect of the present disclosure provides a method for manufacturing an ultrasonic probe. The method for manufacturing an ultrasonic probe includes: a step of manufacturing an acoustic window component according to a manufacturing method for an acoustic window component having the features of the fourth aspect of the present disclosure; a step of preparing a module including an ultrasonic transducer and an acoustic lens for focusing ultrasonic waves generated from the ultrasonic transducer, the acoustic lens having a convex outer surface corresponding to a concave surface of the rear surface of the acoustic window component; a step of coupling the acoustic lens to the module including the ultrasonic transducer with a first adhesive such that the convex outer surface of the acoustic lens is acoustically bonded to the rear surface of the acoustic window component; and a step of coupling the probe case and the first wall portion with a second adhesive so as to internally store at least a portion of the first wall portion.

The second adhesive may be the same or a different adhesive as the first adhesive, the first wall portion and the second wall portion meet at the acute angle at a branching point, and the branching point is filled with the second adhesive.

### BRIEF DESCRIPTION OF THE DRAWINGS

FIG. 1 is a block diagram depicting one example of a schematic configuration of an ultrasonic diagnostic system according to an embodiment of the present invention;

FIG. 2 is a diagram depicting the external structure of the ultrasonic probe;

FIG. 3 is a diagram depicting the external structure of the ultrasonic probe;

FIG. 4 is a cross-sectional view of a probe case cut in half between the front and rear;

FIG. 5 is a diagram depicting the structure of a portion including an acoustic window, corresponding to the upper left portion of FIG. 4;

FIG. 6 is a cross-sectional view of a probe case cut in half between the left and right;

FIG. 7 is a diagram depicting the structure of a comparative example of an acoustic window;

FIG. 8 is a diagram depicting the structure of a portion including an acoustic window, corresponding to the upper left portion of FIG. 6;

FIG. 9 is a perspective view of an acoustic window;

FIG. 10 is a six-view diagram of an acoustic window;

FIG. 11 is a cross-sectional view of an acoustic window; and

FIG. 12 is an exploded perspective view depicting the internal structure of the ultrasonic probe.

### DETAILED DESCRIPTION

Embodiments of the present invention will be described below. Note that the invention claimed in the embodiments described herein is not limited. In particular, in the present disclosure, a medical ultrasonic diagnostic system is described as an example. However, the present invention may be applied to an ultrasonic examination system, an ultrasonic examination device, and an ultrasonic probe for the non-destructive examination of buildings, structures, various mechanical devices, and the like.

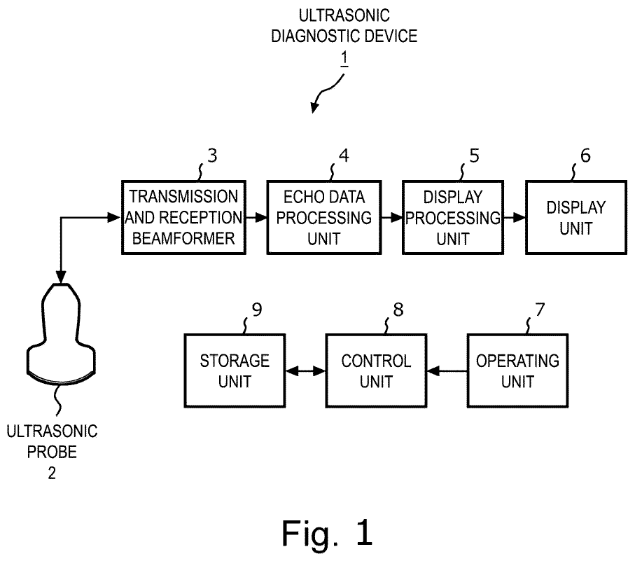

Embodiments of the present invention will be described hereinafter with reference to the drawings. The ultrasonic diagnostic device 1 depicted in FIG. 1 is provided with an ultrasonic probe 2, a transmission and reception beamformer 3, an echo data processing unit 4, a display processing unit 5, a display unit 6, an operating unit 7, a control unit 8, and a storage unit 9. The ultrasonic diagnostic device 1 has a configuration as a computer.

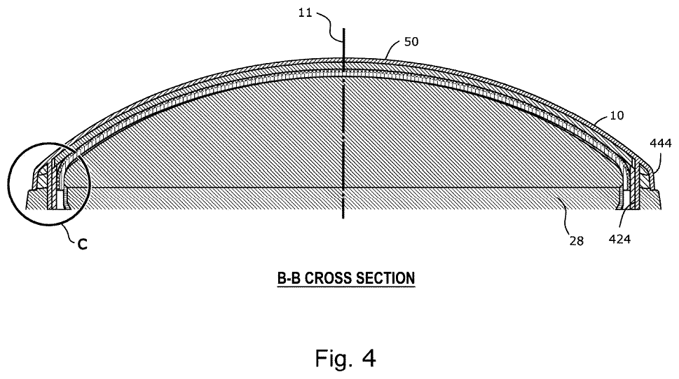

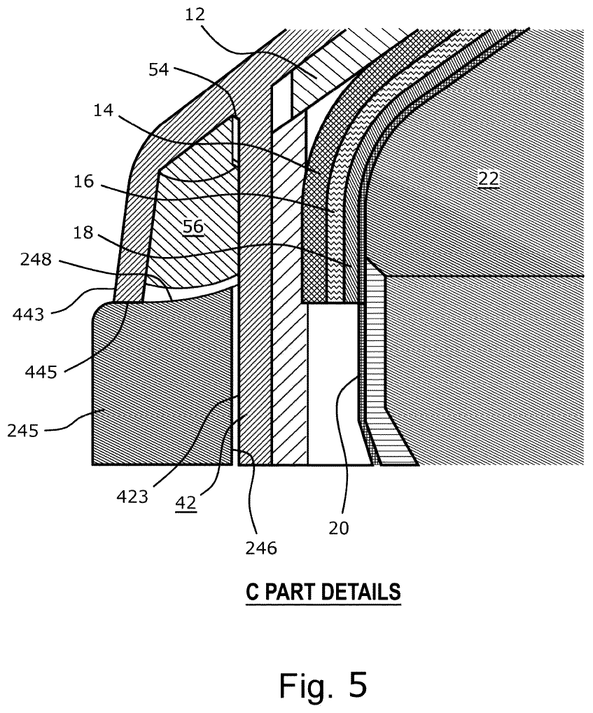

The ultrasonic probe 2 includes a plurality of ultrasonic transducers (see FIG. 4 and FIG. 5) disposed in an array, transmits ultrasonic waves to an examination target by the ultrasonic transducers, and receives an echo signal thereof.

The ultrasonic probe 2 transmits and receives ultrasonic waves to and from an examination target. The transmission and reception beamformer 3 supplies an electric signal for transmitting an ultrasonic wave from the ultrasonic probe 2 under a predetermined scanning condition to the ultrasonic probe 2 on the basis of a control signal from the control unit 8. Furthermore, the transmission and reception beamformer 3 performs signal processing such as A/D conversion and delay-and-sum processing on the echo signal received by the ultrasonic probe 2, and outputs the signal-processed echo data to the echo data processing unit 4.

The echo data processing unit 4 processes the echo data output from the reception and transmission beamformer 3 to create an ultrasonic image.

For example, echo data processing unit 4 creates B-mode data by performing B-mode processing such as logarithmic compression processing or envelope detection processing.

The display processing unit 5 scan-converts data input from the echo data processing unit 4 using a scan converter (scan converter) to create ultrasonic image data. For example, the display processing unit 5 scan-converts B-mode data to create B-mode image data and causes the display unit 6 to display an ultrasonic image on the basis of the ultrasonic image data. The ultrasonic image is, for example, a B-mode image on the basis of the B-mode image data.

The display unit 6 is a liquid crystal display (LCD), an organic electro-luminescence (EL) display, or the like. The operating unit 7 is a device to which a user inputs instructions and information. For example, although not particularly depicted in the drawings, the operating unit 7 includes a keyboard, and also includes a pointing device such as a mouse, a trackball, and the like.

The control unit 8 is, for example, a processor such as a central processing unit (CPU). The control unit 8 reads a program stored in the storage unit 9 and controls each unit of the ultrasonic diagnostic device 1. For example, the control unit 8 reads a program stored in the storage unit 9 and causes the read program to execute the functions of the reception and transmission beamformer 3, the echo data processing unit 4, and the display processing unit 5.

The control unit 8 may execute all of the functions of the reception and transmission beamformer 3, all of the functions of the echo data processing unit 4, and all of the functions of the display processing unit 5 by a program, or may execute only a part of the functions by a program. When the control unit 8 executes only a part of the functions, the remaining functions may be executed by hardware such as a circuit. Note that the functions of the reception and transmission beamformer 3, the echo data processing unit 4, and the display processing unit 5 may be implemented by hardware such as a circuit.

The storage unit 9 is a hard disk drive (HDD), a solid-state drive (SSD), or a semiconductor memory (memory) such as random-access memory (RAM) or read-only memory (ROM), or the like.

The ultrasonic diagnostic device 1 may include all of the HDD, SSD, RAM, and ROM as the storage unit 9. Furthermore, the storage unit 9 may be a portable storage medium such as a compact disk (CD) or a digital versatile disk (DVD). A program executed by the control unit 8 is stored in a non-transient storage medium such as an HDD or a ROM. Furthermore, the program may be stored in a portable non-transient storage medium such as a CD or a DVD.

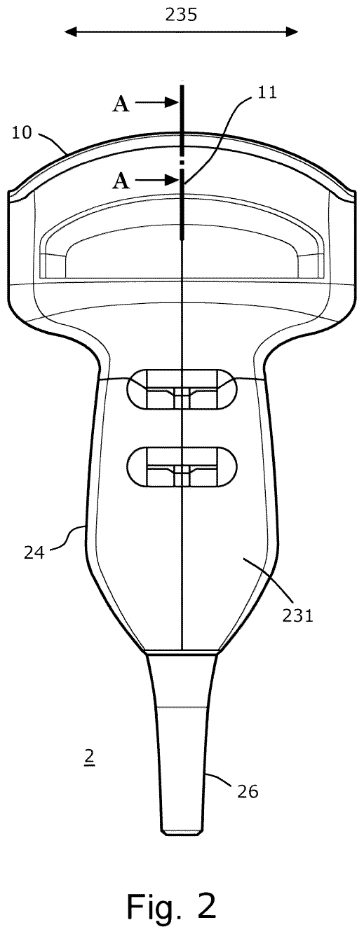

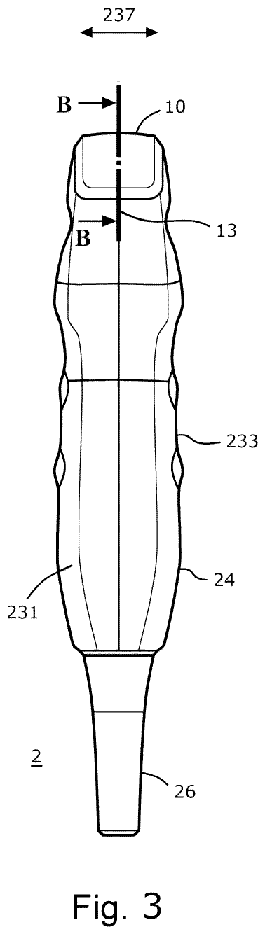

FIGS. 2 and 3 are diagrams depicting the external structure of the ultrasonic probe 2. FIG. 2 is a front view of the ultrasonic probe 2, and FIG. 3 depicts the right side surface of the ultrasonic probe. In the present embodiment, the ultrasonic probe 2 is a convex type ultrasonic probe, but may be another type of ultrasonic probe having an acoustic window with a convex curved surface, such as an ultrasonic probe for a bronchoscope or a transesophageal ultrasonic probe. A convex type ultrasonic probe has an acoustic window 10 with a convex curved surface, and radiates ultrasonic waves that diverge radially. Convex type ultrasonic probes are used for abdominal ultrasonic examinations, and the like.

As depicted in FIGS. 2 and 3, the acoustic window 10 is bonded to the probe case 24 at the tip end of the ultrasonic probe 2. In this example, a cable 26 is joined to the probe case 24 at the rear end of the ultrasonic probe 2. FIG. 2 depicts the probe 2 placed such that the bottom surface 233 (see FIG. 3) is in contact with a supporting surface of the ultrasonic probe 2, such as a desk, table, or the like, so the surface of the probe 2 closer to the user is described as the upper surface 231 and the opposite surface is described as the bottom surface 233. However, in some embodiments, the upper surface 231 and the bottom surface 233 of the probe 2 may be identical in structure. In this case, when the probe 2 is placed upside down, the upper surface 231 of the probe 2 can be referred to as the bottom surface 233, and the bottom surface 233 of the probe 2 can be referred to as the upper surface 231. In consideration, the upper surface 231 and the bottom surface 233 of the probe 2 depicted in FIGS. 2 and 3 can also be seen as the side surfaces of the probe 2, but to facilitate understanding by the reader, these two surfaces will be described as the upper surface 231 and the bottom surface 233 of the probe 2.

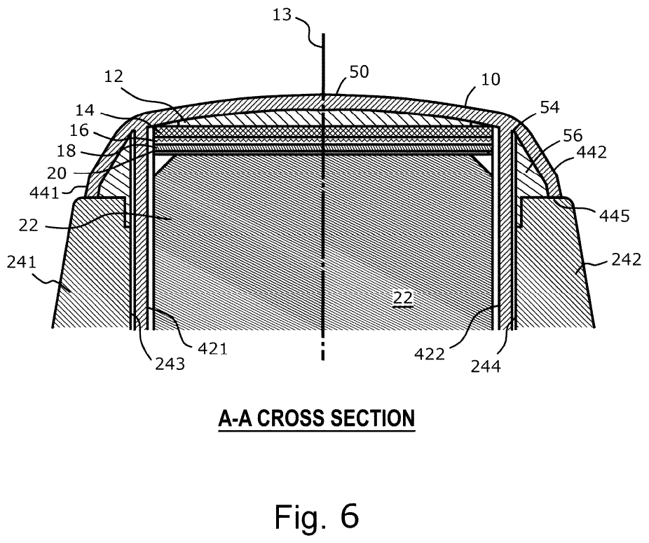

FIG. 4 is a cross-sectional view of an ultrasonic probe 2 according to some embodiments of the present invention, taken along a cross section 13 (see FIG. 3) that bisects the acoustic window 10 and the probe case 24 between front and rear, and FIG. 5 is an enlarged view of a portion of the cross-sectional view. FIG. 6 is a cross-sectional view of the acoustic window 10 and the probe case 24 of the ultrasonic probe 2 according to some embodiments of the present invention, taken along a cross section 11 (see FIG. 2) that bisects left and right. As depicted in FIG. 4, in the present embodiment, the acoustic window 10 has an axisymmetric shape with respect to the cross section 11, and as depicted in FIG. 6, in the present embodiment, the acoustic window 10 has an axisymmetric shape with respect to the cross section 13.

As depicted in FIGS. 4 to 6, the acoustic window 10 in some embodiments of the present invention is positioned so as to cover the acoustic lens 12 and the module 28 containing the transducer 16. The module 28 includes an acoustic matching layer 14, a transducer 16, a reflective layer 18, a flexible substrate 20, and a sound absorbing material 22. The transducer 16 converts an electrical signal into vibration to generate ultrasonic waves, and vibrates upon receiving an echo signal, which is then converted into an electrical signal. An acoustic matching layer 14 having a multi-layer structure is provided on the transducer 16 in order to acoustically match the acoustic impedance of the transducer 16 with the acoustic impedance of the target.

An acoustic lens 12 is provided on the upper surface of the acoustic matching layer 14 to allow the ultrasonic waves to efficiently converge and be incident on the target, so that the ultrasonic waves will be transmitted and received through the acoustic lens. In some embodiments of the present invention, protecting the acoustic lens 12 with an acoustic window 10 allows the acoustic lens 12 to be made of a soft, delicate material that has good acoustic properties, and allows the selection of a material suitable for propagation and refraction of ultrasonic waves. One specific material that can be used for the acoustic lens 12 is silicone rubber, which has an acoustic impedance close to that of water and has excellent moldability and releasability.

The convex surface of the acoustic window 10 that contacts the target can have a uniform thickness in the azimuth direction. Thereby the acoustic window 10 can be produced with the shape and dimensions as designed, reducing the possibility of producing defective products that do not meet the design specifications and improving yields. The acoustic lens 12 has a convex outer surface that corresponds to the concave shape of the rear surface of the acoustic window 10, and the convex outer surface of the acoustic lens 12 is acoustically bonded to the rear surface of the acoustic window 10. In some embodiments, this acoustic coupling is accomplished using an adhesive.

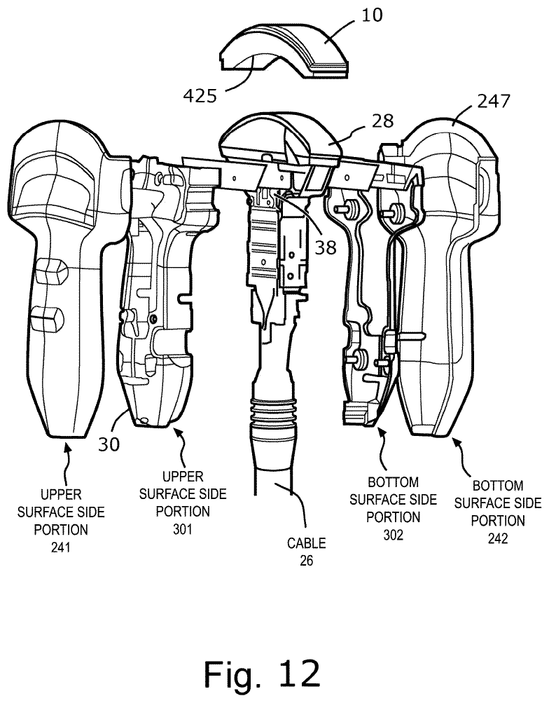

The ultrasonic waves generated by the transducer 16 travel not only forward but also rearward. A reflective layer 18 is provided to reflect ultrasonic waves traveling rearward, and a sound absorbing material 22 is provided to absorb ultrasonic waves traveling rearward, thus suppressing unnecessary vibrations. The flexible substrate 20 serves as a lead wire, transmitting electrical signals from electronic components (not depicted) to the transducer 16 and transmitting electrical signals from the transducer 16 to the electronic components (not depicted). In some embodiments, the acoustic lens 12 is a portion of a module 28 that includes a transducer, and in some embodiments, the acoustic lens 12 is bonded to the module 28 that includes an ultrasonic transducer (FIG. 12) with a first adhesive such that the convex outer surface of the acoustic lens 12 is acoustically bonded to the rear surface of the acoustic window 10. The convex outer surface of the acoustic lens 12 and the rear surface of the acoustic window 10 are also bonded using the first adhesive or another adhesive. The first adhesive and the other adhesive may be a silicone-based adhesive or an epoxy resin-based adhesive.

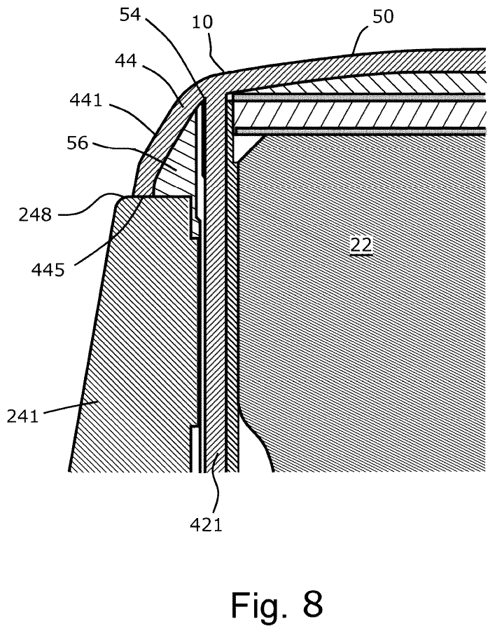

FIG. 8 is a diagram depicting the structure of a portion including an acoustic window 10, corresponding to the upper left portion of FIG. 6. The acoustic window 10 is required to be made of a material whose acoustic impedance is close to that of a living body. Furthermore, if the thickness of the acoustic window 10 is too thin, the strength will be insufficient, and if the acoustic window 10 is subjected to an impact, for example by dropping the ultrasonic probe 2 on the floor, the acoustic window 10 will develop cracks, dents, and the like. On the other hand, if the acoustic window 10 is too thick, ultrasonic waves will be significantly attenuated, leading to a decrease in sensitivity, and there will be problems where the effect of refraction is greater due to the difference in sound speed as compared to a living body. Therefore, the acoustic window 10 must be formed as thin as possible while still maintaining the required robustness.

The inventors of the present invention have provided a wall portion extending from the end part of the acoustic window 10 along the inner surface of the probe case 24, thereby protecting the structural element placed inside the probe case 24 from chemical liquids such as disinfectant, even if the chemical liquids enter the inside of the probe case 24. In particular, the module 28 including the transducer can be protected from the chemical solution, by sandwiching a module 28 (FIG. 12) including a transducer between the first wall portion upper surface side 421 and the first wall portion bottom surface side 422 and covering the module with the probe case 24. Therefore, in some embodiments, the first wall portion upper surface side 421 and the first wall portion bottom surface side 422 are formed to be parallel to each other. Similarly, a module 28 (FIG. 12) including a transducer is sandwiched between the first wall portion left surface side 423 and the first wall portion right surface side 424, and then covered with a probe case 24, thereby protecting the module 28 including the transducer from the chemical solution entering from the side of the probe case 24. Therefore, in some embodiments, the first wall portion left side surface side 423 and the first wall portion right side surface side 424 are formed to be parallel to each other. In some embodiments of the present invention, the first wall portion upper surface side 421, the first wall portion bottom surface side 422, the first wall portion left side surface side 423, and the first wall portion right side surface side 424 are connected to each other, and the module 28 including the transducer can be protected from chemical solutions entering from any direction. In some other embodiments of the present invention, the first wall portion upper surface side 421, the first wall portion bottom surface side 422, the first wall portion left side surface side 423 and the first wall portion right side surface side 424 are not connected to each other.

In some other embodiments of the present invention, the acoustic window 10 is formed from a thermoplastic polymer. The acoustic window 10 is preferably formed from a thermoplastic polymer having a density of 0.80 g/cm³ to 0.90 g/cm³, an acoustic velocity of 1600 mm/msec to 2100 mm/msec, and an acoustic energy attenuation of 2.0 dB/mm to 5.0 dB/mm for 7 MHz sound waves in an environment of 20° C. and 1 atm. Thermoplastic polymers having these properties often have a molding shrinkage rate of 1.0% or more. Thermoplastic polymers expand when melted at elevated temperatures and contract when cooled and hardened in a mold. The mold is made slightly larger than the molded product to take into account the plastic expansion and contraction. The difference between the molded product dimensions and the mold dimensions at this time is the molding shrinkage rate. The mold shrinkage rate varies depending on the type of material, for example, 1.0 to 2.5% for polypropylene and 0.4 to 0.7% for polystyrene.

In some other embodiments of the present invention, the thermoplastic polymer forming the acoustic window 10 contains polymethylpentene. Polymethylpentene has an acoustic impedance of about 1.6 [MRayl], which is close to the acoustic impedance of water, which is approximately 1.55 [MRayl], and is close to that of a living body, and therefore has good acoustic matching with a living body (water). However, the speed of sound through polymethylpentene is about 2000 [m/sec], which is faster than the speed of sound through water, which is about 1550 [m/sec]. The molding shrinkage of polymethylpentene is known to be 1.5 to 3.0%. In some other embodiments of the present invention, the thermoplastic polymer forming the acoustic window 10, polymethylpentene, is blended with an elastomer selected from the polyolefin family. The mixing ratio of the elastomer to the polymethylpentene is 1 wt. % or more and 50 wt. % or less. More preferably, the blending ratio of the elastomer is 10 wt. % or more and 30 wt. % or less. More preferably, the amount of elastomer is about 20 wt. %. Thereby, an acoustic window 10 that is robust, wear resistant, has excellent acoustic properties, and is highly resistant to chemicals can be produced at low cost.

Several advantages arise by having the second wall portion 44 of the acoustic window 10 form a portion of the lateral wall portion of the ultrasonic probe 2 at the tip end portion of the ultrasonic probe 2. One of these advantages is the ability to provide a probe 2 with a tip end that is thin in the elevation direction 237 and yet has sufficient strength. If the thickness in the elevation direction 237 at the tip end of the probe 2 is excessively large, problems may occur, such as increased strain on the target, for example, when positioning the probe 2 between the ribs to image the organs behind the ribs. On the other hand, the inside of the probe case 24 needs to have a certain thickness in the elevation direction in order to ensure space for the structural elements stored therein. Furthermore, there is a limit to how thin the thickness of the integrally molded acoustic window 10 can be made. In addition, if the probe case 24 is extended to the tip end portion 247, the probe case 24 can be provided with a thin portion having a cross section with a sharp angle. However, this portion of the probe case 24 is prone to breakage, and so designing the probe case 24 in this manner (to provide a thin portion having a cross section with a sharp angle) is not appropriate. If the probe case 24 is extended to the tip end portion 247 and the probe case 24 is to have sufficient strength, the cross section of the probe case 24 must be thick to the tip end, and as a result, a probe 2 with a thin tip end in the elevation direction 237 cannot be provided. These conflicting issues (thinness in the elevation direction 237 and maintaining the strength of the tip end portion of the probe 2) can be resolved by having the second wall portion 44 of the acoustic window 10 form a portion of the side surface wall portion at the tip end portion of the ultrasonic probe.

The advantage of the acoustic window 10 being positioned to transition smoothly from the probe case 24 is that the probe 2 can easily be maintained in a hygienic manner. If a large step exists between the acoustic window 10 and the probe case 24, there is a possibility that problems will occur where dirt will easily adhere to the surface and the dirt will be difficult to remove. Furthermore, providing the end part of the probe case 24 to support the end part of the acoustic window 10 enables at least a portion of the load generated at the end part of the acoustic window 10 to be absorbed by the end part of the probe case 24.

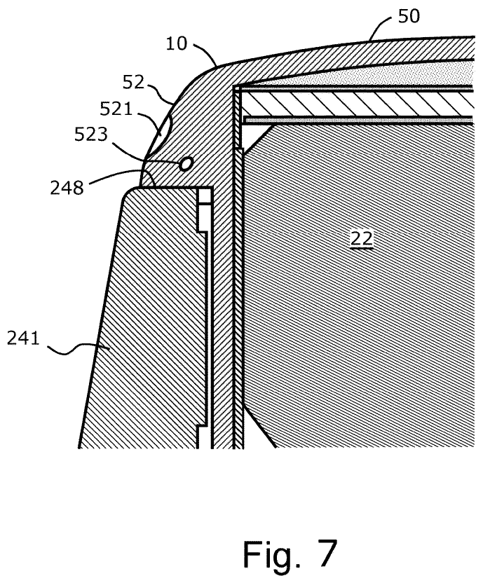

FIG. 7 is a diagram depicting the structure of an acoustic window 10 as a comparative example which has the aforementioned advantages. However, the acoustic window 10 of the comparative example differs from the embodiment of the present invention depicted in FIG. 6 in that, as depicted in FIG. 7, the acoustic window 10 has an overhang portion 52 that protrudes outward from the first wall portion 42 around the entire circumference. As depicted in the figure, the prototype of the acoustic window 10 having this overhang portion 52 had either one or both of sink marks 521 and voids 523 occurring with a frequency and/or probability that could not be ignored.

The acoustic window 10 is formed by injection molding, which can be performed by the following procedure.
1. Preparation of materials
2. Clamping the mold
3. Injection
4. Pressure retention
5. Cooling
6. Plasticization
7. Opening the mold
8. Removing the product

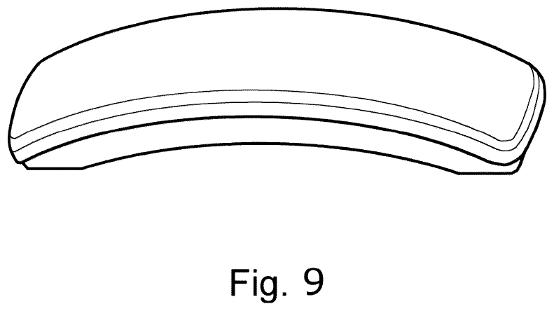

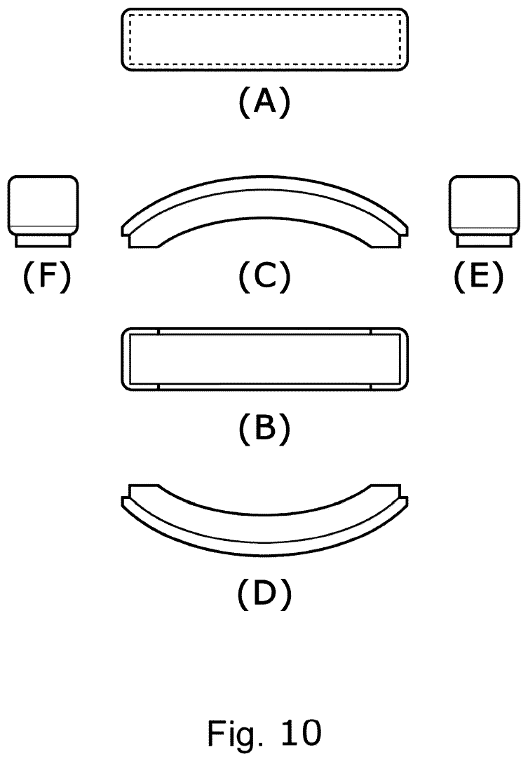

When performing the above procedures, a mold is prepared having an inner surface corresponding to the acoustic window 10 depicted in FIGS. 9 and 10. Furthermore, the acoustic window 10 is also injection molded by injecting molten thermoplastic polymer into a prepared mold. The acoustic window 10 is a one-piece molded part. In this example, an elastomer selected from polyolefins is mixed with polymethylpentene at a mixing ratio of 10 wt. % to 30wt. %, and then injected into a mold.

The inventors of the present invention discovered that the problem of occurrence of sink marks 521 and voids 523 can be solved by changing the overhang portion 52 in FIG. 7 to the second wall portion 44 depicted in FIG. 8. The acoustic window 10 of FIG. 8 can be manufactured using the same materials and by the same injection molding process as the acoustic window 10 of FIG. 7, but the overhang portion 52 of FIG. 7 is composed of a first wall portion 42 and a second wall portion 44 having approximately the same thickness as depicted in FIG. 8, and has a structure with almost no variation in thickness, so as to cool evenly without unevenness, and thus the material also shrinks and hardens evenly. In contrast, the overhang portion 52 in FIG. 7 has a portion close to the outer surface that cools first, and the material in that portion begins to harden and shrink, but the portion farther from the outer surface cools later, and the material in that portion hardens and shrinks later. Such non-uniformity in cooling, hardening, and shrinking is thought to be one of the causes of sink marks 521 and voids 523.

In some embodiments of the present invention, the second wall portion 44 is formed around the entire periphery of the acoustic window 10. In other words, the second wall portion 44 has a second wall portion upper surface side 441, a second wall portion bottom surface side 442, a second wall portion left side surface side 443, and a second wall portion right side surface side 444, which are mutually connected to adjacent sides. In some embodiments of the present invention, as depicted in FIG. 5 and FIG. 8, the second wall portion 44 extends outward from the first wall portion 42 at an acute angle from a branching point 54. A cavity is formed between the first wall portion 42 and the second wall portion 44 of the injection molded acoustic window 10. In some embodiments, the cavity (preferably including the branching point 54) is filled with the first adhesive described above or another adhesive to form an adhesive cavity filler member 56. In some other embodiments, the cavity is filled with a cavity filler member 56 formed from the same material as the acoustic window 10. In this case, the cavity filler member 56 is injection molded to have a shape corresponding to the shape of the cavity between the first wall portion 42 and the second wall portion 44, and is inserted between the first wall portion 42 and the second wall portion 44 and fixed by adhesive. The acoustic window 10 includes a center portion having a relatively large radius of curvature, second wall portions 44 provided on both sides thereof and also having a relatively large radius of curvature, and shoulder parts connecting the central portion and the second wall portions 44. The shoulder part has a relatively small radius of curvature. In some embodiments, the branching point 54 is located below the shoulder part.

In some embodiments, the first wall portion upper surface side 421 and the second wall portion upper surface side 441 are formed to form an angle at the branching point 54 of between 20° and 40°, more preferably between 25° and 35°. The same is true for the first wall portion bottom surface side 422 and the second wall portion bottom surface side 442. In some embodiments, the first wall portion left side surface side 423 and the second wall portion left side surface side 443 are formed to form an angle at the branching point 54 of between 30° and 60°, more preferably between 45° and 55°. The same is true for the first wall portion right side surface 424 and the second wall portion right side surface 444. In the present embodiment, the convex surface 50 of the acoustic window 10, the first wall portion upper surface side 421, the first wall portion bottom surface side 422, the first wall portion left side surface side 423, the first wall portion right side surface side 424, the second wall portion upper surface side 441, the second wall portion bottom surface side 442, the second wall portion left side surface side 443, and the second wall portion right side surface side 444 all have the same thickness. The thickness of the convex surface 50 of the acoustic window 10, the first wall portion upper surface side 421, the first wall portion bottom surface side 422, the first wall portion left side surface side 423, the first wall portion right side surface side 424, the second wall portion upper surface side 441, the second wall portion bottom surface side 442, the second wall portion left side surface side 443, and the second wall portion right side surface side 444 is preferably 0.1 mm to 1.5 mm, more preferably 0.3 mm to 1.0 mm, and even more preferably 0.5 mm. In some embodiments, the second wall portion 44 (including the second wall portion upper surface side 441, the second wall portion bottom surface side 442, the second wall portion left side surface side 443, and the second wall portion right side surface side 444) has an outer surface that is contiguous with the convex surface 50. This reduces the burden on the target.

In some embodiments, as depicted in FIG. 8, the second wall portion upper side 441 is bent at a position of 60% to 90%, more preferably 70% to 80%, of the total length of the second wall portion upper surface side 441 from the branching point 54 to approach the first wall portion upper side 421, so as to move in a direction closer to being parallel to the first wall portion upper surface side 421, and thus the outer surface is smoothly curved. Thereby, the tip end 445 of the second wall portion is well supported by the tip end 248 of the probe case 24, so the adhesive bond between the tip end 445 of the second wall portion and the tip 248 of the probe case 24 is stronger and less likely to break. As depicted in FIG. 8, the outer surface of the second wall portion upper surface side 441 is positioned to be offset from the outer surface of the upper surface side portion 241 of the probe case 24, but the second wall portion upper surface side 441 may be designed so that the outer surface of the second wall portion upper surface side 441 is contiguous with the outer surface of the upper surface side portion 241 of the probe case 24 so that the offset is almost nonexistent. Reducing the offset has the advantage that dirt is less likely to adhere to the step and is easier to remove. The second wall portion bottom surface side 442 can be designed similarly to the second wall portion upper surface side 441.

In some embodiments, as depicted in FIG. 5, the second wall portion left side surface side 443 is bent at a position of 20% to 60%, more preferably 30% to 50%, of the total length of the second wall portion left side surface side 443 from the branching point 54 to approach the first wall portion left side surface side 423, so as to move in a direction closer to being parallel to the first wall portion left side surface side 423, and thus the outer surface is smoothly curved. Thereby, the tip end 445 of the second wall portion is well supported by the tip end 248 of the probe case 24, so the adhesive bond between the tip end 445 of the second wall portion and the tip 248 of the probe case 24 is stronger and less likely to break. As depicted in FIG. 5, the outer surface of the second wall portion left side surface side 443 is positioned offset from the outer surface of the left side surface side portion 245 of the probe case 24, but the second wall portion left side surface side 443 may be designed so that the outer surface of the second wall portion left side surface side 443 is contiguous with the outer surface of the left side surface side portion 245 of the probe case 24 so that the offset is almost nonexistent. Reducing the offset has the advantage that dirt is less likely to adhere to the step and is easier to remove. The second wall portion right side surface side 444 can be designed similarly to the second wall portion left side surface side 443.

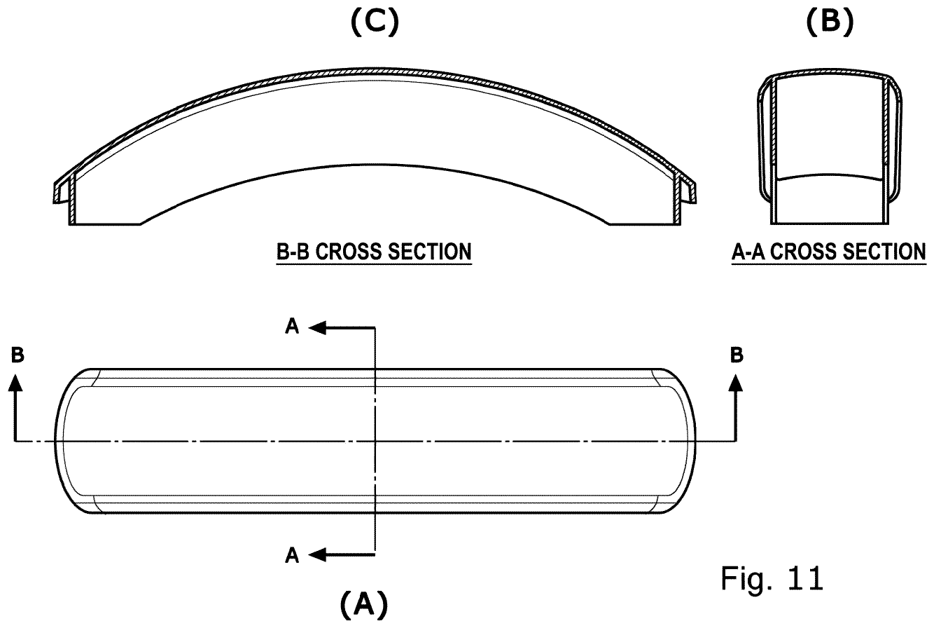

Next, the shape of the acoustic window 10 will be described with reference to FIGS. 9 to 11. FIG. 9 is a perspective view of the acoustic window 10. The acoustic window 10 may have versatility to enable attaching to different types of ultrasonic probes, and the acoustic window 10 may also be sold independently. FIG. 10A is an upper surface view of the acoustic window 10, FIG. 10B is a bottom view of the acoustic window 10, FIG. 10C is a front view of the acoustic window 10, FIG. 10D is a rear view of the acoustic window 10, FIG. 10E is a right side view of the acoustic window 10, and FIG. 10F is a left side view of the acoustic window 10. FIG. 11B is a cross-sectional view of the acoustic window 10 taken along the cross section A-A depicted in FIG. 11A. FIG. 11C is a cross-sectional view of the acoustic window 10 taken along the cross-section B-B depicted in FIG. 11A. In the present embodiment, the acoustic window 10 is made of a translucent material.

FIG. 12 is an exploded perspective view depicting the internal structure of the ultrasonic probe. In the present embodiment, a metallic inner housing 30 is provided inside the probe case 24 of the ultrasonic probe 2. The inner housing 30 diffuses heat generated in the module 28 including the transducer, and prevents the heat generated in the module 28 from being transmitted to the target. The outer surface of the inner housing 30 has a shape conforming to the inner surface of the probe case 24. The inner housing 30 may be manufactured by a known method such as casting, additive manufacturing, CNC processing, forging, or press working. The upper surface side portion 301 and the bottom surface side portion 302 of the inner housing 30 are joined together by an adhesive (first adhesive or another adhesive). The inner surface of the probe case 24 is attached to the outer surface of the inner housing 30 by an adhesive (second adhesive). The upper surface side portion 241 and the bottom surface side portion 242 of the probe case 24 are also joined to each other by an adhesive (the first adhesive or another adhesive). The front end of the probe case 24 is adhered to the acoustic window 10, and the rear end of the probe case 24 is adhered to the cable 26.

A chassis 38 is positioned inside the inner housing 30. A plurality of electronic components (not depicted) is provided inside the chassis 38. The chassis 38 can be fixed to the module 28 containing the transducer by screws, such that the structural element fixed thereto is not easily removed or moved from the prescribed positions in the ultrasonic probe 2. The chassis 38 may also be secured to other structural elements, such as the inner housing 30, using a variety of fastening means known in the art. In a particular embodiment of the present invention, electronic components (not depicted) are removably connected to the cable 26 by a connector (not depicted) and to the module 28 containing the transducer by another connector (not depicted). Thereby power from the cable can be supplied to the electronic components (not depicted) or module 28. Moreover, bidirectional signal transmission via the cable 26 is possible.

In some embodiments of the present invention, an acoustic lens 12 is attached to the rear surface of the acoustic window 10 as depicted in FIG. 12. The module 28 including the transducer and the acoustic lens 12 are also bonded together to be acoustically bonded together. Next, the module 28 including the transducer and the chassis 38 are fixed with screws, and the electronic components of the module 28 including the transducer and the cables are connected using connectors. The upper surface side portion 301 and the bottom surface side portion 302 of the inner housing 30 are joined to each other so as to enclose or sandwich the module 28. Next, the upper surface side portion 241 and the bottom surface side portion 242 of the probe case 24 are joined to each other so as to enclose or interpose these components. The inner surface of the probe case 24 near the tip end has a shape corresponding to the first wall portion. The inner surface of probe case 24 and the first wall portion are bonded with the first adhesive or another adhesive.

The adhesive used for assembling the ultrasonic probe 2 is preferably an adhesive having excellent chemical resistance and ultraviolet ray resistance, such as a silicone adhesive, epoxy resin adhesive, and the like. In terms of miniaturization, it is preferable that the thickness of the adhesive is 5 mm or less. In terms of the strength of the adhesive, it is preferable that the thickness of the adhesive is 0.3 mm or greater. More preferably, the adhesive has a thickness of 1 to 4 mm. The adhesive applied to each part may be the same adhesive or different adhesives.

According to an aspect, a method for manufacturing an acoustic window component may include a step of preparing a mold having an inner surface corresponding to the acoustic window component; and a step of injection molding the acoustic window component by injecting a molten thermoplastic polymer into the mold. The method may also include a step of preparing a module including an ultrasonic transducer and an acoustic lens for focusing ultrasonic waves generated by the ultrasonic transducer, the acoustic lens having a convex outer surface corresponding to a concave rear surface of the acoustic window component; a step of coupling the acoustic lens to the module including the ultrasonic transducer with a first adhesive such that the convex outer surface of the acoustic lens is acoustically bonded to the rear surface of the acoustic window component; and a step of bonding the probe case and the first wall portion with a second adhesive so as to internally store at least a portion of the first wall portion. The second adhesive may be the same as or different from the first adhesive; the first wall portion and the second wall portion meet at the acute angle at a branching point; and the branch point is filled with the second adhesive.

Note that the invention is not limited to the present embodiment, and various modifications are possible without departing from the gist of the invention.

### Description of Codes

1. Ultrasonic diagnostic device
2. Ultrasonic probe
3. Transmission and reception beamformer
4. Echo data processing unit
5. Display processing unit
6. Display unit
7. Operating unit
8. Control unit
9. Storage unit
10. Acoustic window
11, 13. Cross section
12. Acoustic lens
14. Acoustic matching layer
16. Transducer
18. Reflective layer
20. Flexible substrate
22. Sound absorbing material
231. Upper surface of probe
233. Bottom surface of probe
235. Azimuth direction
237. Elevation direction
24. Probe case
241. Upper surface side portion
242. Bottom surface side portion
243. Inner surface of upper surface side portion
244. Inner surface of bottom surface side portion
245. Left side surface side portion
246. Inner surface of left side surface side portion
247. Tip end portion
248. Tip end
26. Cable
28. Module including transducer
30. Inner housing
301. Upper surface side portion
302. Bottom surface side portion
38. Chassis
42. First wall portion
421. First wall portion upper surface side
422. First wall portion bottom surface side
423. First wall portion left side surface side
424. First wall portion right side surface side
425. Tip end of first wall portion
44. Second wall portion
441. Second wall portion upper surface side
442. Second wall portion bottom surface side
443. Second wall portion left side surface side
444. Second wall portion right side surface side
445. Tip end of second wall portion
50. Convex surface
52. Overhang portion
521. Sink
523. Void
54. Branching point
56. Void filling material

1. An acoustic window component positioned at an end part of the ultrasonic probe relative to the probe case, comprising:
a convex surface extending in an azimuth direction and contacting an examination target; and
a first wall portion and a second wall portion extending divergently from each other,
wherein at least a portion of the first wall portion is provided along an inner surface of the probe case; and
the second wall portion has an outer surface that is contiguous with the convex surface.

2. The acoustic window component according to claim 1, wherein the first wall portion and the second wall portion diverge at an acute angle at the peripheral edge part of the convex surface.

3. The acoustic window component according to claim 2, wherein the first wall portion has approximately the same thickness as the second wall portion.

4. The acoustic window component according to claim 1, wherein the acoustic window component is made of a thermoplastic polymer, and the thermoplastic polymer has a molding shrinkage rate of 1.0% or more.

5. The acoustic window component according to claim 1, wherein the acoustic window component is formed of an elastomer selected from polymethylpentene, which is a thermoplastic polymer, blended with a polyolefin-based elastomer; and
the blending ratio of the elastomer is from 1 wt. % to 50 wt. %.

6. The acoustic window component according to claim 5, wherein the blending ratio of the elastomer is between 10 wt. % or more and 30 wt. % or less.

7. The acoustic window component according to claim 2, wherein
the first wall portion includes a front surface portion extending along a front surface of the ultrasonic probe, and a rear surface portion extending along a rear surface of the ultrasonic probe; and
the front surface portion of the first wall portion and the rear surface portion of the first wall portion extend parallel to each other, separated in an elevation direction 237.

8. The acoustic window component according to claim 7, wherein
the first wall portion includes a right side surface portion extending along a right side surface of the ultrasonic probe, and a left side surface portion extending along a left side surface of the ultrasonic probe; and
the right side surface portion of the first wall portion and the left side surface portion of the first wall portion extend parallel to each other, separated in an azimuth direction 235.

9. The acoustic window component according to claim 2, wherein the second wall portion includes a front surface portion extending along a front surface of the ultrasonic probe, and a rear surface portion extending along a rear surface of the ultrasonic probe.

10. The acoustic window component according to claim 9, wherein
the outer surface of the front surface portion of the second wall portion and the convex surface of the acoustic window component are connected to each other by a contiguous curve in a cross section dividing the ultrasonic probe into left and right halves; and
an outer surface of the rear surface portion of the second wall portion and the convex surface of the acoustic window component are connected to each other in the cross section dividing the left and right sides by a contiguous curve.

11. The acoustic window component according to claim 10, wherein the second wall portion includes a right side surface portion extending along a right side surface of the ultrasonic probe and a left side surface portion extending along a left side surface of the ultrasonic probe.

12. The acoustic window component according to claim 1, wherein the thickness of the convex surface is constant across the azimuth direction.

13. The acoustic window component according to claim 12, wherein the thickness of the convex surface is 0.1 mm or more.

14. The acoustic window component according to claim 1, wherein the acoustic window component is an integrated molded component.

15. An ultrasonic probe, comprising:
an acoustic window component comprising:
a convex surface extending in an azimuth direction and contacting an examination target; and
a first wall portion and a second wall portion extending divergently from each other, wherein at least a portion of the first wall portion is provided along an inner surface of the probe case; and the second wall portion has an outer surface that is contiguous with the convex surface;
a module including an ultrasonic transducer and an acoustic lens that focuses ultrasonic waves generated by the ultrasonic transducer; and
a probe case for internally storing the main body of the ultrasonic probe,
wherein the acoustic lens has a convex outer surface that corresponds to the concave shape of the rear surface of the acoustic window component; and
wherein the convex outer surface of the acoustic lens is acoustically bonded to the rear surface of the acoustic window component.

16. The ultrasonic probe according to claim 15, wherein
the first wall portion extends between the probe case and the transducer module; and
the second wall portion has an outer surface that is contiguous with an outer surface of the front end of the probe case.

17. The ultrasonic probe according to claim 15, wherein the ultrasonic probe is a convex type ultrasonic probe.

18. An ultrasonic diagnostic device comprising:
the ultrasonic probe according to claim 15;
an image processing unit that generates an ultrasonic image based on the ultrasonic signals collected by the ultrasonic probe; and
a display device for displaying the ultrasonic image.
